(19) United States
(12) Patent Application Publication
(10) Pub. No.: US 2017/0140458 A1
(43) Pub. Date: May 18, 2017

(54) METHOD OF ESTIMATING TENANCY DURATION AND MOBILITY IN RENTAL PROPERTIES

(71) Applicant: Douglas Mallach, Mill Valley, CA (US)

(72) Inventor: Douglas Mallach, Mill Valley, CA (US)

(21) Appl. No.: 15/340,859

(22) Filed: Nov. 1, 2016

Related U.S. Application Data
(60) Provisional application No. 62/254,437, filed on Nov. 12, 2015.

(51) Int. Cl. G06Q 30/06; G06F 17/30

(52) U.S. Cl. CPC G06Q 30/0645; G06F 17/30554; G06F 17/30528

(57) ABSTRACT

Electronic tenancy duration/mobility predictive analysis system and business method for determining tenant duration/mobility trends using a computer or web hosted system employing a warehouse data module including a plurality of tenant profile databases, each tenant profile database containing a list of tenant profile data points and factors, a computer interface hosting a result engine operated by a software algorithm programmed to examine sets of tenant profile data points in order to find relevant correlations relating to tenant duration/mobility information; a correlation data module for receiving, storing and sharing said relevant correlations in digital electronic form expressed as a correlation index or percentage; and a website hosting a reporting module in communication with the warehouse data module, the result engine and the correlation data module for receiving said tenant profile data points and a reporting module for reporting the results.

### PRIORITY

This application claims the benefit of co-pending provisional patent application 62/254,437 entitled “Method of Estimating Tenancy Duration and Mobility in Multi-Family Properties” filed Nov. 12, 2015 by the same inventor, which is incorporated by reference as if fully set forth herein.

### FIELD OF THE DISCLOSURE

The present disclosure relates in general to an electronic tenancy duration/mobility predictive analysis business method, and in particular to a system and method for determining rental tenant duration/mobility factors for rental properties located within rent regulated controlled areas in order to assist property owners and managers, property buyers, and investors in financial instruments that derive their value in whole or part from such properties (the “Interested Parties”) in selecting prospective tenants and/or evaluating in-place tenants based on a collection of tenant parameters and other associated data points and factors relating to tenant behavior.

Conventionally there are three main methods of fixing maximum rents have been employed in various parts of the world: the “fair rents” system, under which some attempt is made to fix rents for individual buildings or dwelling units on a basis of fairness to the landlord and the tenant; the “percentage” method, whereby rents are fixed on an over-all basis at a percentage of the value of the property; and the “maximum rent date” method. The latter is the most commonly applied approach modernly. (John W. Willis, “Fair Rent Systems”, 16 Geo. Wash. L. Rev. 104 (1947); “Maximum Rents: The “Percentage” Method”, 23 Temp. L. Q. 122 (1949)).

The basic theory of the “maximum rent date” or “freeze” method of controlling rents is that maximum rents are fixed with relation to the rents actually charged for the particular property, or comparable property, on a given date or during a given period. Many variations have been rung on this theme; many exceptions are made or adjustments allowed, but the basic idea has been employed more widely than any other method of regulating rents.

The first step in applying the maximum rent date system is of course the selection of a maximum rent date. The purpose is to choose a date on which rents on the whole were reasonable and had not yet been affected by the abnormal conditions which made control necessary. The date should not be too far in the past since the more remote the date, the more difficult it becomes to ascertain what any particular rent was at that time. The selection of any particular date is of course to a large degree arbitrary; it cannot be otherwise. Another issue with this approach is that it favors “bullish real-estate manipulators” who raised rents before the maximum rent date at the expense of those landlords who did not. Further, rents do not change on a particular date, and non-occupancy periods which depress overall rental income complicate attempts to monetize rents determined by averaging rental incomes over a particular time range. In the U.S., most major rent regulated markets temporarily deregulate, or partially deregulate upon vacancy, conferring upon an owner the opportunity to raise rents to fair market value, or to a significantly higher rent than would otherwise be available to the owner without the occurrence of a vacancy.

Remaining issues with this, as well with all of the rental control approaches however, is that the determination of a rental rate for a particular rental unit within a particular building within a particular rental region becomes arbitrarily fixed in time, even if reasonably fair to both the tenant and rental unit owner at the time, as the rent control approach fails to take into account the inconsistent nature of tenancy duration/mobility amongst tenants, where vacancies constitute rent increase opportunities. Consequently, the rental unit owner is often not capable of raising rents to maintain a fair profit level (or conversely lowering rents to remain competitive and attractive amongst the rental community) over time once rental price fixing is mandated and the rental rates are frozen. Furthermore, buyers and investors must presume current tenants will perpetually renew their leases, or use pro forma assumptions that don't indicate at what point in time such assumptions will take effect in reality.

What is needed is an approach that enables interested parties to determine tenant duration/mobility factors, so that owners can obtain as close to fair market rental value as is allowable, based on actual tenant and rental unit history of other similar rental opportunities and tenants both within and outside the immediate rental controlled area, and other interested parties have an opportunity to evaluate in-place tenants in order to more accurately estimate future cash flows. This information, being based and calculated using actual tenant and prospective tenant-supplied data, general historical data related to other tenants, residents and properties, and other related relevant data, can serve a user in selecting optimal tenants, obtaining rents at or closer to fair market value for rental units, and obtaining a competitive advantage for buyers or investors, and further mitigating the consequences of rent regulation. Conversely, such an approach would accommodate interested parties in markets not subject to rent regulation as they seek to identify tenants most likely to maintain lengthy lease terms, and accept rent increases.

### SUMMARY OF THE DISCLOSURE

The present disclosure relates generally to an electronic tenant duration/mobility predictive analysis business method. designed to address various problems experienced by interested parties focused on rental properties, including apartment buildings, single family dwellings, condominiums, cooperatives, etc., that are located in areas controlled by rental ordnances, regulations, rent stabilization, or rent control legislation. Managers and owners of rental properties located within rent controlled locations are subject to a high degree of variation related to income and property values based on the velocity of tenant turnover which results in episodes of rental unit vacancies. Vacancies of rental units within rent controlled areas are often regarded to be a valuable commodity, as they represent the opportunity to raise existing rents to prices at or closer to prevailing market prices, the magnitude of the rental increases often being considerable and from severely suppressed historical rental fee levels which typically no longer reflect an average or fair market rental valuation with respect to the presently vacant rental property, or comparable properties, within the rent controlled area.

Higher turnover velocity, being the rate at which current, existing tenants are replaced by new renters, usually equates with both higher rental revenues and a higher property value for properties located in rent controlled areas. There is currently no business method, service or product offered to interested parties that operates to accurately and statistically forecast the length of time, or occupancy a prospective tenant that is actively seeking a new rental opportunity within the rent controlled area is likely to maintain their residence at their next rental address, and/or to accurately and statistically forecast the length of time, or tenancy duration, an in-place tenant is likely to maintain their residence at their current address.

A technique to accurately forecast the occupancy and duration/mobility parameters, as well as other parameters that are precursors to prevailing fair market rental prices, or as close to fair market rental prices as local regulation accommodates, is currently not available, but is highly desirable. The present disclosure relates to the ability to accurately forecasting these aforementioned parameters based on tenant information that is obtained from tenants and prospective tenants, as well as general historical data related to other tenants, properties, and people from other sources; the data stored in a tenant profile database and operated upon by a program and algorithms designed to find correlations between a plurality of data points or factors comprising the tenant information, the algorithm(s) then generating tenant duration/mobility/probabilities based on these correlations, and reporting these probabilities in regards to the desired parameters to a user.

### BRIEF DESCRIPTION OF THE DRAWINGS

FIG. 1 is a schematic diagram of one embodiment of a user network interface according one embodiment of the current disclosure.

FIG. 2 is a schematic block diagram of one embodiment of a user network interface showing tenant, user, data and computer processing interrelationships of the present disclosure.

FIG. 3 is a schematic block diagram of one embodiment of the present disclosure showing the correlation data module, data warehouse module, result engine and network and website server modules.

FIG. 4 represents yet another embodiment according to the current disclosure.

FIG. 5 shows a representative graph of tenant duration.

### LEXICOGRAPHY

Unless otherwise defined in the attached specifications, the following words should be construed accordingly.

The term “tenant profile” generally refers to a collective set of data and parameters corresponding to the information related to a particular tenant, including biographical, biometric, financial, legal, employment, and historical data, as well as other related data, information, pictures and the like associated with a tenant, their spouse or a co-renter or co-leasee of the tenant.

The term “tenant profile database” generally refers to a computer database or other such electronically based storage medium that operates to receive and store relevant tenant data points and factors corresponding to a tenant or prospective tenants biographical, personal employment, financial, and historical information as well as other relevant data and information related to the tenant, including spouses, family members, co-renters and co-lessees related to the tenant or prospective tenant.

The term “correlation algorithm” generally refers to algorithms in the form of executable code, executable steps and software programs that access one or more tenant profile databases and data stored within either the tenant profile database, the warehouse storage module, or both, and which then calculates correlation factors expressed either in percentage terms (0 to 100%) or a correlation index (0 to 1.0), or other formats deemed to accurately convey the nature of the correlations between any given set of correlatable data points within any one or more databases associated with the current disclosure.

The term “correlation database” generally refers to a database or storage means that operates to receive and store relevant correlation factors generated or used by the correlation algorithm(s), the correlation database being designed to be a resource containing correlated user and tenant data associated by a correlative index which determines the relevancy of that particular data set with regards to the desired output.

The term “data warehouse module” generally refers to a database or storage means that operates to host all tenant and user data in the form of readable and writeable databases, and further hosts the calculated results and output from both the correlation data module and the result engine.

The term “result engine” generally refers to a computing device or means of computing results which has at least the one function of communicating with the correlation data module to identify instances of correlative data, and optionally has the additional function of assigning weighting factors to correlated data to reflect the degree of relevancy and cross-correlation between a tenant data point and a stored data entry.

The term “customer interface/website” generally refers to a real or virtual webpage or world wide web access point that operates to provide an access point for operation, access points including, but not limited to direct line, internet, wi-fi and wireless access point connectivity, in order to facilitate communications (the uploading, exchange, downloading, storage and manipulation of data) between multiple tenants, users and the computer system employed to host and execute the current disclosure.

The term “declarative language” generally refers to a programming language that allows programming by defining the boundary conditions and constraints and letting the computer determine a solution that meets these requirements. Many languages applying this style attempt to minimize or eliminate side effects by describing what the program should accomplish, rather than describing how to go about accomplishing it. This is in contrast with imperative programming, which requires an explicitly provided algorithm.

The terms “fabric” or “switched fabric” generally refers to a network topology where network nodes connect with each other via one or more network switches and abstracted by one or more layers of software including virtualization at the server level and a hierarchical grouping level.

The term “fault diagnosis,” generally refers to software containing methods that can isolate the stack, rack, cluster or module causing the error. Fault isolation may be accomplished by building in test circuits and/or by dividing operations into multiple regions or components that can be monitored separately. After fault isolation is accomplished, services can be replaced. Fault detection differs from fault isolation because fault detection generally means determining that a problem has occurred, whereas fault isolation pinpoints the exact cause or location of the error.

The word “middleware” generally means computer software that connects software components or applications. The software consists of a set of enabling services that allow multiple processes running on one or more machines to interact across a network. Middleware conventionally provides for interoperability in support of complex, distributed applications. It often includes web servers, application servers, and similar tools that support application development and delivery such as XML, SOAP, and service-oriented architecture.

The term “Internet Protocol Security” (IPsec) generally means a protocol suite for securing Internet Protocol (IP) communications by authenticating and encrypting each IP packet of a communication session.

The term “Layer 2 Tunneling Protocol” (L2TP) generally means a tunneling protocol used to support virtual private networks (VPNs) or as part of the delivery of services by ISPs. It does not provide any encryption or confidentiality by itself. Rather, it relies on an encryption protocol that it passes within the tunnel to provide privacy.

The term “Kernel” generally means the core of the operating system. It normally has full access to all memory and machine hardware and is conventionally a restricted operating area.

The term “service level agreement” (SLA) generally means an agreement between providers for Internet based computing resources such as servers, databases, and data storage systems and clients. SLAs generally contain details about what services are available, pricing for those services and availability for those resources. SLAs may also include workload, queue size, disk space availability, CPU load, network latency, or business metrics such as cost or location.

The word “stack” or “logical stack” generally refers to a set of software subsystems or components needed to deliver a fully functional solution, e.g. a product or service. Often a stack may include an operating system, a server, a data management system and a scripting or other form of programming language. Stacks may be configured in a variety of ways depending on the desire function of the system. Stacks may be collections of elements or they may be represented by pointers (or links) the elements themselves.

The term “User Space” generally refers to a software architecture that restricts user programs so they can't alter memory (and other resources) owned by other programs or by the OS kernel.

The term “virtual machine” or “VM” generally refers to a self-contained operating environment that behaves as if it is a separate computer even though is part of a separate computer or may be virtualized using resources from multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### DETAILED DESCRIPTION

In one embodiment of the present disclosure, is a system and technique featuring a plurality of data points or factors (tenant information) stored within one or a plurality of databases (tenant profile databases) with said tenant information derived from tenant profiles; a set of programs and algorithms designed to identify correlations amongst the stored tenant information; and one or a plurality of tenant profile database(s) each having one or more sets of tenant information stored therein that has been imputed by prospective tenants, current tenants and from other sources, including the owner or manager of the rental property and other developers/operators.

In a further embodiment is a system and method that can access the data stored within the tenant profile databases to find sets of data that are correlated to one another, that then operates to determine a correlation percentage or correlation index related to said sets of data. In yet another embodiment of the present disclosure, an analysis operates to determine tenant duration/mobility data relating the number, frequency, extent and locations of previous rental situations enjoyed by a tenant or prospective tenant. In a further embodiment of the disclosure, is a program or algorithm associated with tenancy data that calculates and identifies correlations amongst the plurality of data points or factors that match a specific tenant profile; and a website that serves as the customer interface to tenants, owners (users) and the like.

In one embodiment, a tenant profile database is comprised of personal and historical data related to tenants of residential properties including apartments, single family dwellings, condominiums, and the like; data sets related to industries, employers, work locations and the like within the rental area in question; job titles, income, as well as associated data relating to potential income, bonuses, salaries and the like; data sets related to specific properties and their tenant histories; personal and family biometric data; and other sets of tenant data points or factors disclosed herein and disclosed also in Table 1. In other embodiments, the sources of data stored within one or more tenant profile databases are myriad and wide ranging, further including, but not limited to data related to tenancy duration/mobility derived from public records, data purchased from private parties and businesses; data gathered from social and business networks and other internet based sources; and data derived from surveys, etc. In another embodiment of the present disclosure, each unique tenant profile data base is dynamic, with additions and corrections being made to the respective tenant profile database constantly when such additions or corrections are made available to the user and are subsequently entered into the database in order to keep the information accurate and current.

TABLE 1
Representative List of Tenant Data and Factors

| Factor # | Tenant Factors |
|---|---|
| 1 | Name |
| 2 | Current Address |
| 3 | Age or Date of Birth |
| 4 | Sex |
| 5 | Marital Status |
| 6 | Marital History |
| 7 | Education |
| 8 | Cohabitants |
| 9 | Social security number |
| 10 | Income |
| 11 | Financial statement |
| 12 | State SS# issued |
| 13 | Date SS# issued |
| 14 | Previous addresses |
| 15 | Dates at previous addresses |
| 16 | Current telephone number |
| 17 | Previous telephone numbers |
| 18 | Dates of previous telephone numbers |
| 19 | Email addresses |
| 20 | Employer (and additional related data) |
| 21 | Job title |
| 22 | Properties currently owned |
| 23 | Previous properties owned |
| 24 | Dates of previously owned properties |
| 25 | Bankruptcy information |
| 26 | Judgments or Liens |
| 27 | Corporation/partnership affiliations |
| 28 | Fictitious business records |
| 29 | Investment holdings |
| 30 | Credit history |
| 31 | Law suits |
| 32 | Criminal records |
| 33 | Driving record |
| 34 | Spouse (and all of the above data for spouse) |
| 35 | Relatives (and all of the above data listed for relatives) |
| 36 | Health insurance data |
| 37 | Health care data |
| 38 | Automobile |
| 39 | Automobile history |
| 40 | Religious activity |
| 41 | Political affiliation |
| 42 | Political donations |
| 43 | Actuarial data |
| 44 | Pets |
| 45 | Travel habits |

In one embodiment of the present disclosure, the tenant profile database provides a source of stored data points imputed to and used by a set of software programs and algorithms in order to identify correlations between the data points related to tenant duration/mobility history as well as other correlations between other data points within the tenant profile database, and data points located within related tenant profile databases relating to one or more commonly rented properties by one or more tenants in common.

In further embodiments of the present disclosure are the correlations described herein as calculated by a correlation data module, the calculated correlation indexes helping populate (inform) an additional correlation database that is in communication with the tenant profile database, both of which are associated with the data warehouse module, either physically or virtually, and capable of the imputing, storing and outputting of data.

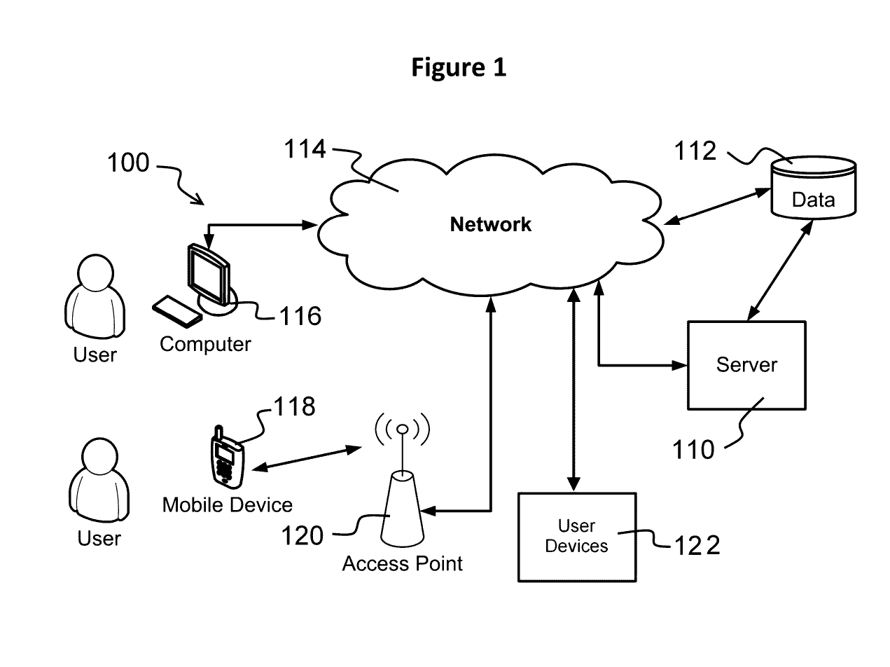

FIG. 1 shows a functional block diagram of a client server system 100 that may be employed for some embodiments according to the current disclosure. The embodiment of the present disclosure shown in FIG. 1 details system components of the current disclosure 100, showing various interface devices, such as a computer 116 and mobile device 118, both devices 116 and 118 being employed by tenants, prospective tenants, owners and users of the current disclosure to communicate data and resulting calculations by means of a network 114 that provides a means for communication with users through an access point 120 (optionally via cable, wire, wireless transmission, wi-fl, ethernet, phone line or other similar electronic communications system) in addition to a means for data storage 112. In further embodiments a server 110 hosting the algorithms and programs employed by one or more devices used to collect, store and analyze data, and other user devices 122 as required. In one embodiment, the server 110 hosts a data storage device 112 and operates via the network 114 for either direct access (shown by the connected arrows between computer 116 and network 114) or remote access by users for the purpose of communicating using a remote device such as access point 120. In other embodiments, the user devices 122 include a means for inputting and exporting data, storing and accessing said data, performing calculations and analysis on said data, storing and accessing results of said calculations and analysis, and reporting said results of said calculations and analysis to a user, optionally, but not limited to means including a computer 116 or smart phone or mobile device 118, or the like. In other embodiments of the disclosure, the business rental method 100 employs a computer or other similar calculating device capable of executing coded instructions derived from algorithms and computer programs, and communicates via said computer with the data 112, server 110 and network 114 devices by means of user interfaces 116 and 118, as well as via other user devices 122 described herein. With respect to the operative modules that can be employed by the disclosed business rental method, FIG. 1 shows a server 110 coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

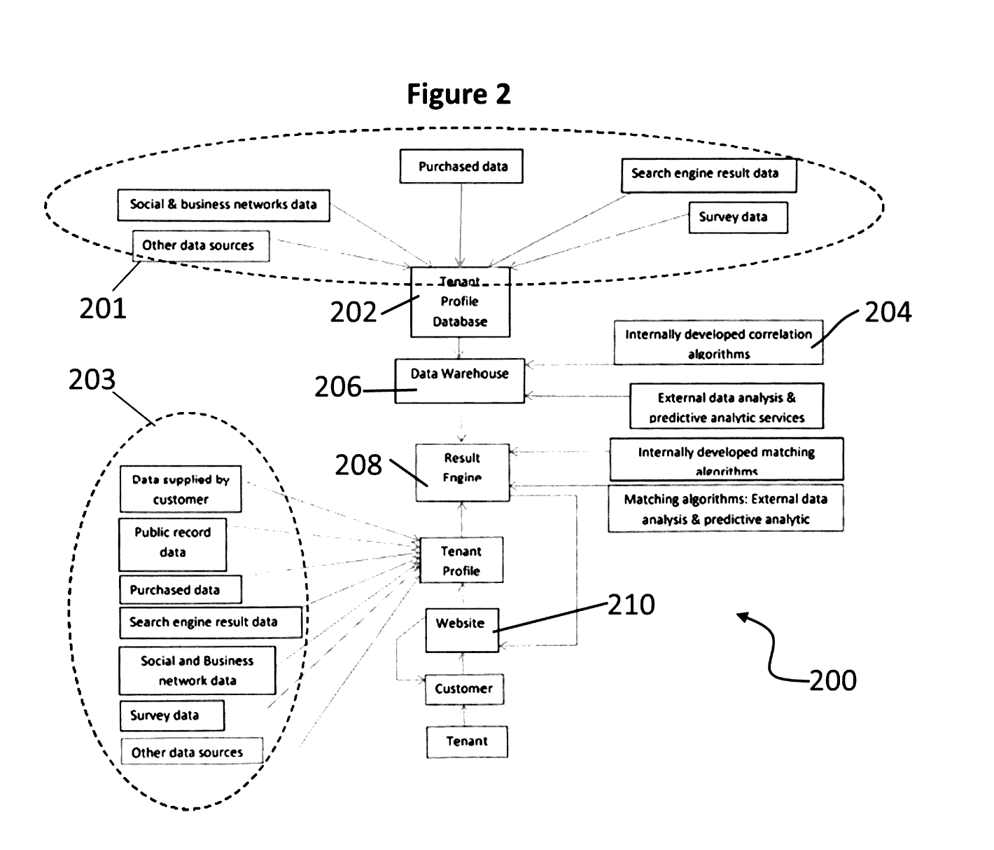

Another embodiment of the present disclosure 200 is shown schematically in FIG. 2, the system components being shown in block diagram form associated with corresponding data and data sources used by this disclosure. In one embodiment, a tenant profile database 202 that is used to store and access a plurality of tenant and other informational data points and factors, collectively identified as 201, including, but not limited to data obtained from, search engine results, survey data, social and business network data, purchased data, and the like. In a further embodiment, the tenant profile database 202 also hosts data supplied by tenants and prospective tenants, collectively identified as 203 and including, but not limited to data reported by the tenant, reported by users, public records traceable to the tenant, purchased data related to the tenant, survey data related to the tenant, social and business network data related to the tenant, and other data sources with information that relate to the tenant or prospective tenant of interest that individually and collectively contribute to and reflect the particular tenant's personal profile. In a related embodiment, the above collection of data points and factors are stored within a tenant profile database 202 in communication with a data warehouse 206 hosting a collection of data points and factors obtained from the tenant profile database 202 as well as the results of calculations, correlations and other data generated by the algorithms and programs used. In one embodiment, the result engine 208 accesses data and information stored within either one or both the tenant profile database 202 and the data warehouse 206, and then subsequently operates upon said data using one or more internally developed correlation algorithms 204 that operate to identify correlations between tenant data sets, correlations between tenant and stored data sets, and correlations between stored data sets, and combinations thereof. In another related embodiment, the result engine 208 accesses data and information stored within either or both the tenant profile database 202 and the data warehouse 206, and then subsequently operates upon said data using one or more external data analysis or predictive analytical services 205 to identify correlations between tenant data sets, correlations between tenant and stored data sets, and correlations between stored data sets, and combinations thereof. In yet another embodiment of the present disclosure, the result engine 208 accesses data and information stored within either or both the tenant profile database 202 and the data warehouse 206, and then subsequently operates upon said data using internally developed matching algorithms 207 that operate to identify matched data sets between tenant, prospective tenant and user data points that are available for further analysis and correlative calculations. In yet another embodiment of the present disclosure, the result engine 208 accesses data and information stored within either or both the tenant profile database 202 and the data warehouse 206, and then subsequently operates upon said data using matching algorithms 209, that are hosted externally and provide external data analysis and predictive analytical results after analyzing selected data sets. Other embodiments of the present disclosure, are is hosted or accessible via a website 210, which is accessible to the user (owner, customer), the tenant, prospective tenants, and the like.

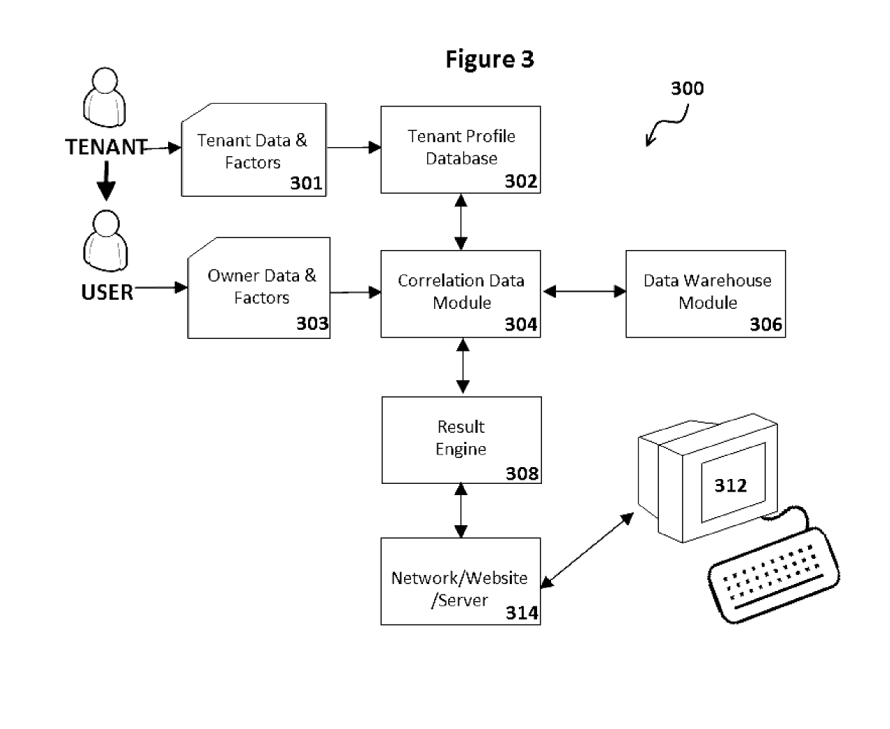

One embodiment of the present disclosure is shown schematically in FIG. 3. In this particular embodiment of the disclosure, a correlation data module 304 is designed to be a resource capable of accessing user or owner data and factors 303, and tenant data and factors 301 that are stored within a tenant profile database 302 and within a data warehouse module 306, respectively. The factors are collected about the owner and the tenant; however, the data itself need not be supplied by the owner or tenant. For example and without limitation tenant and user data may be supplied by a credit reporting service, or through social media, industry analysis data sources and the like. In other embodiments, portions of the information may come from the users or tenants themselves.

In certain embodiments, data may be stored within the data warehouse module 306 which also hosts the tenant profile database 302. In yet another embodiment, the correlation data module 304 hosts a computer executable form of a set of algorithms and programs which operate to identify one or more sets of correlated data between tenant profile database 302 entries and entries within the data warehouse module 306. In a related embodiment, the algorithms and programs are compiled, hosted and executed by the result engine 308, which may be associated with a computer module or virtual processing module that operates to run the correlation software executable code originally expressed as a set of algorithms and programs. In one embodiment, the result engine 308 communicates with the correlation data module 304 and operates to match data points of a specific tenant profile obtained from the tenant profile database 302 with data stored within the data warehouse module 306 to calculate tenant duration/mobility correlations 307 (not shown) based on the number of and the extent of correlation between one or more sets of tenant duration/mobility correlations 307 (not shown). In further embodiments of the present disclosure, the one or more sets of tenant duration/mobility correlations 307 are then used to forecast the tenant's mobility profile 309 (not shown) based on which, how many, and to what extent the tenant data and factors 301 match other related data stored within the data warehouse module 306 originating with owner (user) data and factors 303, as well as other tenant data and factors of other tenants (305, not shown) previously imputed and accessible to the correlation data module 304 and the result engine 308.

In yet another embodiment, the result engine 308 is further programmed to determine how much weight to assign to each set of calculated tenant duration/mobility correlations 307, so that in addition to the number of correlative data points identified by the correlation data module 304 and the relative correlative index determined between said sets of data points, the result engine 308 further operates to assign a weighting factor (typically from zero to 1.0), being a multiplicative factor with respect to the overall significance of that one particular tenant duration/mobility correlation 307 within the set of tenant duration/mobility correlations (collectively, 307 for each tenant) of interest for a particular tenant or rental unit associated with the selected tenant or prospective tenant.

In another embodiment, the result engine 308 calculates and reports either the percentage correlation or a multiplicative correlation index to the user (owner) as disclosed herein, by means of one or more combinations of a network, website and server 314, which operate to provide a communications means for the input of data by both tenant and user and subsequently operates to provide a communications means for the display of data and calculations to the user. In a related embodiment to that immediately above, the result engine further assigns a weighting factor and multiples that by the calculated percentage correlation or multiplicative correlation index to produce one or more weighted correlation coefficients, which are reported instead.

In one embodiment, a website 316 (not shown) acts as an interface for both the tenant and users (owners). In another embodiment, the website 316 is hosted on a network 318 (not shown) or alternatively is hosted on a server 320 (not shown), or alternatively on a combined network server module 322 (not shown) that operates as the communication means for prospective tenants, tenants and users to accesses the service.

In one embodiment, the website 316 includes fields in which a user, such as a customer, enters some basic data related to a tenant or prospective tenant (i.e. name, current address, age, etc.). This tenant data forms the basis upon which a tenant profile is developed. The tenant profile is comprised of the data supplied by the customer and supplemented with additional data that may already exist in the database, as well as additional data that is subsequently gathered from public records, search engines, social and business network data, data purchased from data collection services, and other sources. In some embodiments, the tenant profile may be comprised of data points that include, but are not limited to, those listed in Table 1.

In yet another embodiment of the present disclosure, the result engine 308 operates to cross reference data stored within the tenant profile database 302, using the correlation data module 304 to determine which data points correlate with tenant duration/mobility. The result engine 308 programs and algorithms are designed to assign appropriate data weighting characteristics (correlation index or percentage) to each set of data categories of the tenant profile of data and factors, 301. The algorithms operate to generate results that include, but are not limited to: (1) the length of time a tenant is most likely to stay at his current or next residence; (2) the quantitative probability (optionally expressed as a percentage) that the tenant will move within a next selected time period (optionally related to the rental term or lease duration or arbitrarily some number of months such as 1, 12, 36, for example); (3) the probability (optionally expressed as a percentage) of the accuracy of the result; and (4) other forecasts and predictions in additional formats deemed applicable, such as but not limited to, calculated fair market rental value, maximum rental value bearable within the rental market, default rates by tenant, and tenant ranking factors and the like.

### Operations

In operation a user may enter information about a prospective tenant into the interface of a processing device. The processing device may then rate that likelihood of that prospective tenant vacating the rental premises within a certain time frame. The user may enter information about several prospective tenants and the processing system may perform a comparison indicating which of the prospective tenants will relocate within a predetermined (say 6 months) time frame.

Operations may use multi-variable correlations or probabilities to determined the expect life of a prospective tenancy. For example and without limitation, a high income tenant who works more than 5 miles away from the residential unit may be significantly more likely to vacate the premise within 2 years than a high income tenant who works within walking distance of the residential unit.

In yet other operations a user may enter demographic information about the location of a rental property, including desirable tenants, local employment statistics coupled with one or more of the tenant data points or factors disclosed herein or disclosed also in Table 1. Once entered the processing system may show values for unknown tenant factors, thus presenting information about desirable tenant candidates. In situations where the property manager desires long-term tenants, the processing system may show tenant factors wherein the tenant is more likely to remain in the property. Alternatively, the processing system may show tenant factors wherein a tenant is likely to relocate within a short amount of time. The information generated may be used to target promotional or advertising activity for rental of the facility.

While examples and embodiments supplied have focused on residential rental units, this application should not be construed so narrowly as to exclude commercial properties and tenants as well.

### System Elements

### Processing System

The methods and techniques described herein may be performed on a processor based device. The processor based device will generally comprise a processor attached to one or more memory devices or other tools for the input, storage and output of data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively the entire processing system may be self-contained on a single device.

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, pocket pagers and terminals as well as remote connected computer systems, modems, radio transmitters and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” or “module” which include processor-readable instructions (or “executable” code) to effectuate different elements of a design. Each engine may be responsible for differing operations and may reside in whole or in part on a client, server or other device. As disclosed herein a display engine for user interoperability, a data engine for data storage and processing, an execution engine for method processing, and a user interface (UI) engine and the like may be employed. These engines may seek and gather information about events from remote data sources and provide information to, and collect information from users.

In an exemplary embodiment one engine may collect data from a user, pass that data to a processing engine which calculates correlations and provides that data back to a presentation engine.

### Correlation Data Module

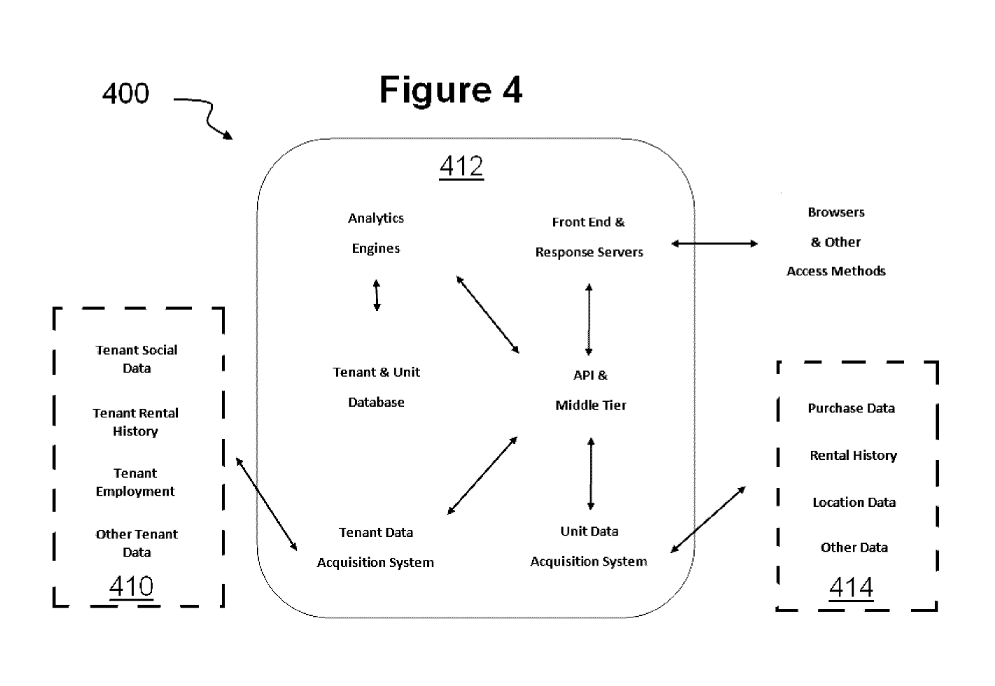

FIG. 4 represents yet another embodiment 400 according to the current disclosure. In FIG. 4 tenant information 410 is coupled to a Tenant Data Acquisition System in a network enabled processing system 412. The processing system 412 includes data storage, processing units, analytics engines, acquisition systems and response server as disclosed herein. The processing system 412 is further coupled to unit data 414 through a Unit Data Acquisition System in the processing system 412.

In operation the processing system 412 exposes an application programming interface (API) to a front end (or response) server which, in turn, provides access methods such as through a browser. A browser user may select from predetermined tenant and unit data or may enter their own information to initiate operation. The API would then interact with the various data and analytic engines to service requests which would be presented to the browser interface.

In one embodiment of the present disclosure, the correlation data module operates to access data records, data and factors (data entries) that are stored in the tenant profile database and in the data warehouse module (data sources) and compares selected individual data entries with other individual data entries within the two data sources, logging each incident of data comparison with a correlation factor or correlation percentage that is based on the similarity of the data entries to one another. Non-correlated data entries are then assigned either zero or arbitrarily low correlation factor to indicate that a correlation process or event has occurred comparing the data points, and optionally the results are stored in a correlation database that may be located in virtual space, or within one or more of the tenant profile database, the data warehouse, the results engine, or combinations thereof.

In one embodiment of the disclosure, correlated data entries that have some commonality in value, degree, source or identity (for example, a rental rate reported by an existing tenant in one property with a rental rate reported by a second tenant in an adjacent property) are then assigned a non-zero correlation factor or correlation percentage based on the degree of similarity.

In another embodiment of the present disclosure, the correlation data module is programmed to operate on every new data entry that is added into either a new or existing tenant profile database and in the data warehouse module so that the correlation data module continues to perform correlations on all new or updated information, so that the resulting correlation data is kept up to date and is revised as new information is received and processed according to the current disclosure.

In a related embodiment, the correlation data module operates to calculate and then store the results of its calculations in the form of a data listing that contains the correlation factor and the type of information correlated, and optionally includes the source (address or location) of the two correlated data entries.

In yet another related embodiment, the correlation data module operates to calculate and then store the results of its calculations in the form of a data listing that contains the correlation factor and includes the source (address or location) of the two correlated data entries.

In further embodiments of the disclosure, the correlation data module stores temporarily stores sets of correlated data entries and further operates to calculate and then store the results of its calculations in the form of a data listing that contains the correlation factor between a previously correlated set of data and a new data entry.

In further embodiments of the disclosure, the correlation data module further operates to calculate and then store the results of its calculations from comparing two previously correlated sets of data to find a third correlation factor or percentage that is based on the similarity of the two previously correlated sets of data, resulting in the calculation and storage of a second-order correlation between the two correlated sets of data.

In further embodiments of the disclosure, this iterative process may continue until all data entries have been correlated against all other data entries, and optionally all correlated sets of data have subsequently been further correlated in a second operation by calculating a correlation factor with respect to other selected correlated sets of data. In embodiments of the disclosure employing this second operation providing a second-order correlation, the results are useful in finding trends and similarities in sets of data originating from multiple tenant profile data entries, lowering the possibility of uncorrelated data sets or weakly correlated data sets from dominating the results of the calculations.

In yet further embodiments, the correlation data module stores the results of its calculations within a storage area within or associated with the correlation data module so that the results are accessible by other components of the system for additional access, calculations, interrogation, updating, reading and transferring of the results to other components of the system.

### Results Engine

In a further embodiment of the disclosure, the results engine operates to access the results of the correlation data module and operates to assign a weighting factor to each data entry, the weighting factor being a fractional number between 0 and 1 reflecting the relative weight or relevancy of that particular data entry to be considered in further calculations, reporting or other applications employing an algorithm or program to evaluate said data entry.

In a related embodiment of the disclosure, the results engine operates to access the results of the correlation data module and operates to assign a weighting factor to each set of correlated data as output or calculated by the correlation data module, the weighting factor being a fractional number between 0 and 1 reflecting the relative weight or relevancy of that particular set of correlated data to be considered in further calculations, reporting or other applications employing an algorithm or program to evaluate said set of correlated data.

In further embodiments of the disclosure, the results engine operates to calculate and then store the weighting factor of each evaluated data entry or each set of correlated data entries, optionally including the source (address or location) of the data entry or of the two correlated data entries.

In yet another related embodiment, the results engine operates to calculate and then store the results of its calculations in the form of a data listing that contains the weighting factor and includes the source (address or location) of the data entry or of the two correlated data entries.

In yet further embodiments of the disclosure, the results engine operates to calculate and then store the results of its calculations derived by assigned an additional weighting factor to sets of correlated data entries.

In other embodiments of the disclosure, the results engine operates to access the stored results of its calculations of weighting factors and operates to display or communicate the weighting results of each data entry or set of correlated data entries to the user, either in graphical form, statistical form, visual form, or some other form of visual communication or representation enabling the weights and correlation factors of the various data entries and correlated sets of data to be visualized by the user in order to more readily determine patterns and trends in the data that are ranked according to relative correlation factors and weighting factors assigned by the correlation data module and the results engine.

In other embodiments of the disclosure, the results engine operates to display the stored results of its calculations of weighting factors ordered by the magnitude of the weighting factor, and then optionally ordered by the magnitude of the individual correlation factors of the data entries or of selected sets of correlated data entries.

In an embodiment of the disclosure, the results engine uses the results of its calculations of weighting factors in combination with the results of the correlation data module to calculate individual tenant duration/mobility statistics, which include, but are not limited to, those statistics relating to the length of residency at the present rental location, physical distance between a previous and a present rental unit, rental price differential between a previous and the present rental unit cost, number of times tenant has changed rental apartments in a given time period, number of times tenant has executed a new lease at each rental location, and other information relating to tenant behavior associated with searching for, finding, securing and executing a lease or rental agreement or the like for a selected rental property.

In a further embodiment of the disclosure, the results engine operates to display the results of its calculations relating to tenant mobility statistics to the user, optionally ranked in order of the magnitude of the weighting factor, or the magnitude of the product of the weighting factor and correlation factors, or the magnitude of the correlation factors relating to a selected tenant or selected tenant data set or selected rental property, or combination thereof.

In yet another embodiment of the disclosure the results engine operates to statistically determine a fair market rental value for a particular rental unit by using the relative correlation factors and weighting factors assigned by the correlation data module and the results engine with regard to past and present rental rates at that particular rental unit combined with collective tenant duration/mobility data, which then incorporates into the fair market rental value the cost value associated with tenant duration/mobility. For example, in two similar apartment rental situations with statistically similar fair market rental values, the rental opportunity having a greater flux of tenants (tenant duration/mobility) over a selected time period, will have a different valuation than one enjoying a lower flux of tenants. The fair market rental valuation would likely be lower if the tenant duration/mobility data correlates to a lower continued occupancy rate, and higher if the tenant duration/mobility data correlates to a higher continued occupancy rate, for example, reflecting the statistical trend of more tenants leaving that particular rental unit in a given time-period (therefore higher vacancy and lower overall rental income flowing to the rental unit in a given time period equating to a lower fair market rental value) as contrasted to the opposite statistical trend of more tenants flowing to that particular rental unit, which would then equate to a higher fair market rental value because the demand for those rental units would be greater, as reflected by higher mobility and lower vacancy rates.

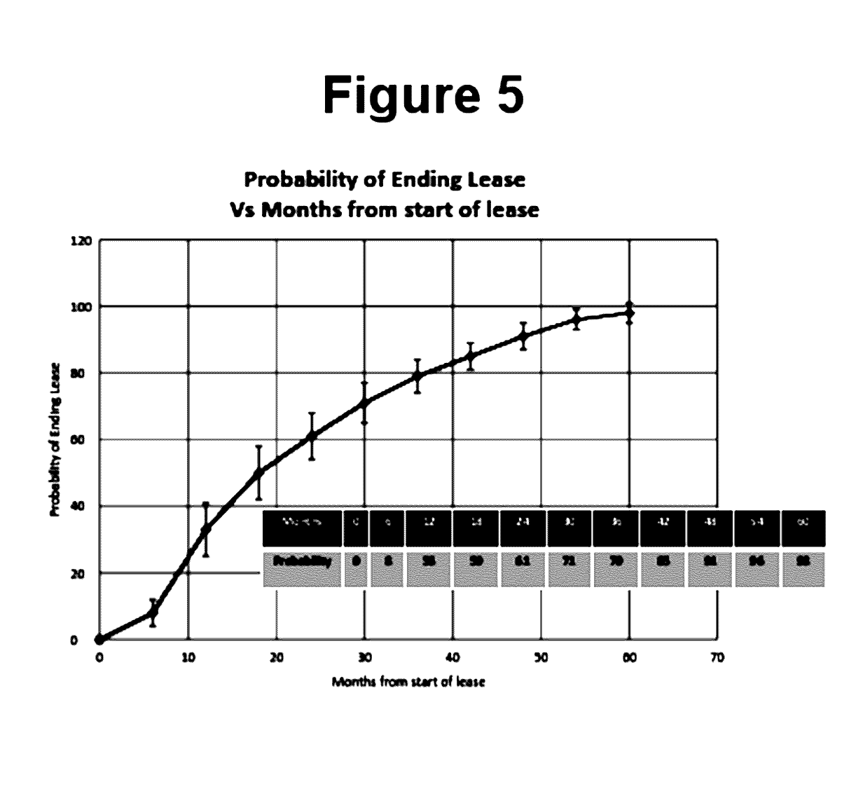

FIG. 5 shows a representative example of a result that may be effectuated using the system, techniques and methods of the current disclosure. Certain embodiments include an indicia of the relative probability of a tenant lease duration along with an indicator of event certainty.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of any claims. Accordingly, it is appropriate that any claims be construed broadly and in a manner consistent with the scope of the invention.

I claim:

1. A system including:
a structured data source, said structured data including a tenant profile information, and a tenant mobility information;
a correlation module, said correlation module operable to examine said tenant information, and, in response to said examining, determine relevant correlations between said tenant profile information and the tenant mobility information, said correlation module further operable to calculate a correlation index, and
a user interface engine, said user interface engine operable to receive prospective tenant information, compare the prospective tenant information with the correlation index and display an indicia of prospective tenant mobility.

2. The system of claim 1 wherein the tenant profile information includes demographic and employment information about a natural person.

3. The system of claim 1 wherein the tenant profile information includes at least one of a prospective tenants biographical, personal employment, financial, historical, spouses, family members, co-renters and co-lessees information.

4. The system of claim 1 wherein the tenant mobility information includes at least one of a fair market rental information, or a historical tenancy information.

5. The system of claim 1 wherein said correlation index is a quantitative probability that the prospective tenant will move within a predetermined time frame.

6. The system of claim 1 wherein the correlation index includes one or more weighting factors between a tenant profile information, and a tenant mobility information.

7. The device of claim 1 wherein the user interface engine is effectuated, at least in part, using an application programming interface

8. A method to forecast occupancy and mobility information including:
receiving, at a networked server, prospective tenant information;
receiving historical tenancy data;
correlating the tenant information and the historical tenancy data to determine a probability that prospective tenant will change residences within a given time frame.

9. The method of claim 8 wherein the prospective tenant information includes at least one of a biographical, employment, financial, spouse, relative, co-renters and co-lessees information, and the historical tenancy information includes historical data related to tenants of a residential property.

10. A processor readable memory, said memory encoded with non-transitory processor readable instructions directing a processor to perform a method comprising:
receiving prospective tenant information, said prospective tenant information including tenant demographic information;
receiving historical tenancy data;
correlating the tenant information and the historical tenancy data to determine a probability that prospective tenant will change residences within a given time frame, and
providing the results of said correlating to a user.

11. The device of claim 10 wherein at least one of the receiving prospective tenant information or receiving historical tenancy data is effectuate using an application programming interface.

12. The device of claim 10 wherein the historical tenancy data includes demographic and employment information about a natural person.

13. The device of claim 10 wherein the prospective tenant information includes at least one of a prospective tenants biographical, personal employment, financial, historical, spouses, family members, co-renters and co-lessee's information.

14. The device of claim 10 wherein said providing the results of said correlating is effectuated over a network.

15. The device of claim 10 wherein said correlating includes assigning weighting factors to reflect the degree of relevancy and cross-correlation between the tenant information and the historical tenancy data.

16. The device of claim 10 wherein the historical tenancy data includes at least one of local industries, local employers, local work locations, a magnitude of historical rent increases, and rental turnover velocity.
